(19) United States
(12) Patent Application Publication
(10) Pub. No.: US 2008/0260209 A1
(43) Pub. Date: Oct. 23, 2008

(54) IMAGE PROCESSING APPARATUS AND METHOD

(75) Inventor: Atsushi YABUSHITA, Kanagawa (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/037,385

(22) Filed: Feb. 26, 2008

(30) Foreign Application Priority Data
Mar. 15, 2007 (JP) 2007-066022

(51) Int. Cl. G06K 9/00; G06K 9/36

(52) U.S. Cl. 382/107; 382/284

(57) ABSTRACT

A location predicting unit predicts a composing location based on the composing locations corresponding to partial images of one-frame-before and two-frames-before the current partial image on an assumption that the above partial image moves at a constant speed, and gives the above predicted value to a combining unit as an initial value. The combining unit moves locations of the current partial image and the one-frame-before partial image pixel by pixel in a predetermined direction starting from the initial value and combines the above partial images each other. A picture element comparing unit and a location determining unit calculate the cumulative value of the brightness differentials between picture elements of the current partial image and the one-frame-before partial image in the overlapped part with respect to each of the combining locations. In the above operation, the calculation of the cumulative value corresponding to the currently-calculated combining location is finished when the above currently-calculated cumulative value exceeds the cumulative value corresponding to the already-calculated combining location.

### BACKGROUND OF THE INVENTION

1. Field of the Invention

The present invention relates to an image processing apparatus and method for combining picture elements having overlapped parts to compose a composite image.

This is a counterpart of Japanese patent application Serial Number 066022/2007, filed on Mar. 15, 2007, the subject matter of which is incorporated herein by reference.

2. Description of the Related Art

FIG. 2 is a configuration diagram of the conventional image processing apparatus described in the following patent document 1. The above image processing apparatus is for authentication of a fingerprint by reading the fingerprint by moving relatively the fingerprint and a sensor having the same lateral width of 1 to 2.5 cm as fingers and a lengthwise width of around 0.5 to 5 mm, and includes a sensor 1 for getting a fingerprint image and a partial image memory 2 for storing the partial images of the fingerprint outputted periodically from the above sensor 1.

A composing location calculating circuit 3 and a composed image memory 4 are connected to the above partial image memory 2. The composing location calculating circuit 3 compares a partial image of the current frame and a partial image of the prior frame given from the partial image memory 2 and calculates the location giving the best resemblance to the overlapped images.

The composed image memory 4 stores a composite image composed by combining the partial images. An authentication circuit 5 is connected the composed image memory 4. An authentication circuit 5 is connected to the partial image memory 4, and after a composite composed image of fingerprint is stored in the above composed image memory 4, the authentication circuit 5 authenticates the fingerprint using the above composite composed fingerprint image.

Furthermore, the composing location calculating circuit 3 consists of a combing unit 3a for combining a prior-in-time input frame and a current input frame and extracting a overlapped part out of the above combined images, an picture element selecting unit 3b for selecting picture elements out of the above extracted overlapped part in order to calculate differential between the prior frame and the current frame, a picture element comparing unit 3c for calculating differential between picture elements selected by the image selecting unit 3b and comparing the cumulative value of the above differential with a cumulative value of a differential in the case of changing the combining location, and a location determining unit 3d for determining the combining location to minimize the cumulative value of the differential based on the result of the picture element comparing unit 3c.

FIG. 3 is a process flow diagram showing an operation of the combining location calculating circuit of FIG. 2. The combining process in the lengthwise frame direction will be explained as below, however, the same operation as in the lengthwise direction is done in the lateral direction.

When the above operation is started, a relative combining location A between the prior frame and the current frame is set to zero (step S1). The case where the relative location A=0 indicates the state that the prior frame and the current frame are overlapped completely each other, and every time the relative location A is incremented by one, the relative location A indicates the state that the relative location between the prior frame and the current frame is moved downward by one picture element length. After the relative location A is determined (step S2), it is judged whether or not the overlapped part between the current frame and the prior frame needs to be differentiated (step S3). In the case where the above overlapped part picture elements do not need to be differentiated, the process is proceeded to step S6, and in the case where the above overlapped part picture elements needs to be differentiated, the picture element levels are differentiated (step S4).

The calculated level differential of the picture elements is added to the cumulative value (step S5), and whether the process of the overlapped parts is competed or not is judged (step S6). In the case where the process is not completed, the process is returned back to the step S2. In the case where the process is completed, the current calculated cumulative value and the previous calculated cumulative value are compared each other (step S7), and in the case where the current calculated cumulative value is smaller than the previous calculated cumulative value, the combing location is updated by the current relative location A (step S8).

When combining the current frame and the prior frame is finished, in the case where the relative location A is M−1 (M: the number of the pixels along the lengthwise frame direction) (step S9), the composite process is finished. In the case where the relative location A does not reach to M−1, the relative location A is added by 1 and the process is returned to the step S2.

FIG. 4 is a explanatory diagram of the operation of FIG. 2. In FIG. 2, the case where the frame size is 12×8 pixels is take as an example for explanation of the general procedure.

When the process is stared, the relative location A is set to 0, and the differential of picture levels is calculated between all of the overlapped picture elements of the current and prior frames being necessary to be differentiated in the process (1).

In the following process (2), the relative location A is added by 1 to 1, and the cumulative value is calculated similarly. In the above process, when the cumulative value is assumed to be 45, since the cumulative value is larger than the previous cumulative value, the previous cumulative value is not updated, and the following cumulative value for A=2 is calculated. When the cumulative value of picture elements to be differentiated at A=2 is assumed to be 30, since the cumulative value is smaller than the previous cumulative value, the above value of 30 is held as an updated value, and the relative location A=2 is held as the combining location at the same time. The above process is repeated till the process (8) for A=7, and then the relative location A holding the minimum cumulative value (in the case of FIG. 4, A=3) is outputted as the combing location for recomposing the image.

Patent document 1: Japanese Patent Laid-open Number 2003-331269.

### SUMMARY OF THE INVENTION

However, in above-mentioned combing location calculation circuit 3, the cumulative value for all of the picture elements to be differentiated are calculated sequentially for all of the relative locations A for combing, and the calculated cumulative value is compared to the previous cumulative value.

Consequently, in the case where the input frame size becomes larger, a problem arises that the process quantity becomes larger due to increasing in number of the picture elements of accumulating the differential and the process time to complete the authentication becomes longer.

Meanwhile, a method to reduce the number of the picture elements for accumulating the differential is possible in order to reduce the process time, however, there is a possibility that the precision for combing becomes worse when the number of the picture element is reduced.

The object of the present invention is reducing the process time for calculating the combing location without reducing the combing precision in the image processing for composing the composite image from the partial images.

The present invention relates to an image processing apparatus for composing a composite image by combing partial images sequentially acquired by moving relatively the reading object of image and an image sensor having smaller reading area than the above reading object of image.

Furthermore, the present invention is characterized by including an accumulating device to calculate a cumulative value of brightness differentials between each of the picture elements in the overlapped part at the current combing location after moving relatively the current and one-frame-before partial images by one picture element length at one time, a composing location determining device to output a combining location having the minimum cumulative value out of the cumulative values calculated by the above accumulating device as the composing location, and an image combing device to combine the current and the one-frame-before partial images based on the above mentioned composing location, and the present invention is characterized by configuration that the above mentioned accumulating device finishes the process of accumulating for the current combining location when the cumulative value becomes larger than the cumulative value of the already-calculated composing location on the way of calculating the above cumulative value for each of the combing locations.

The present invention has the configuration that the above mentioned accumulating device finishes the accumulating process for the current combining location when the cumulative value becomes larger than the cumulative value of the already-calculated combing location on the way of calculating a cumulative value of brightness differentials between each of the picture elements in the overlapped part at each of the combing locations after moving relatively the current and one-frame-before partial images by one picture element length at one time. By the above configuration, the redundancy of calculation to the end without consideration the cumulative value for each of the combing locations can be eliminated, and then there is an effect that the process time for calculating the composing location can be reduced without reducing the combing precision.

### BRIEF DESCRIPTION OF THE DRAWINGS

FIG. 1: A configuration diagram of a composing location calculating circuit according to the first embodiment of the present invention.

FIG. 2: A configuration diagram of the conventional image processing apparatus.

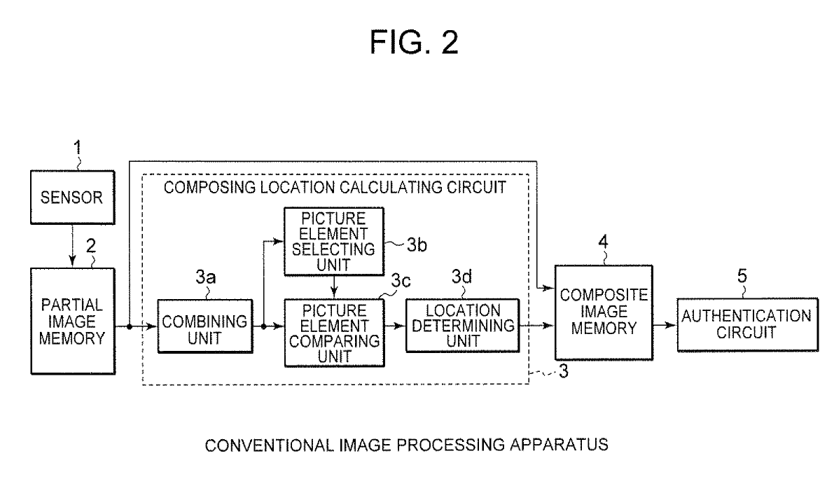

FIG. 3: A process flow diagram of the operation of the composing location calculating circuit in FIG. 2.

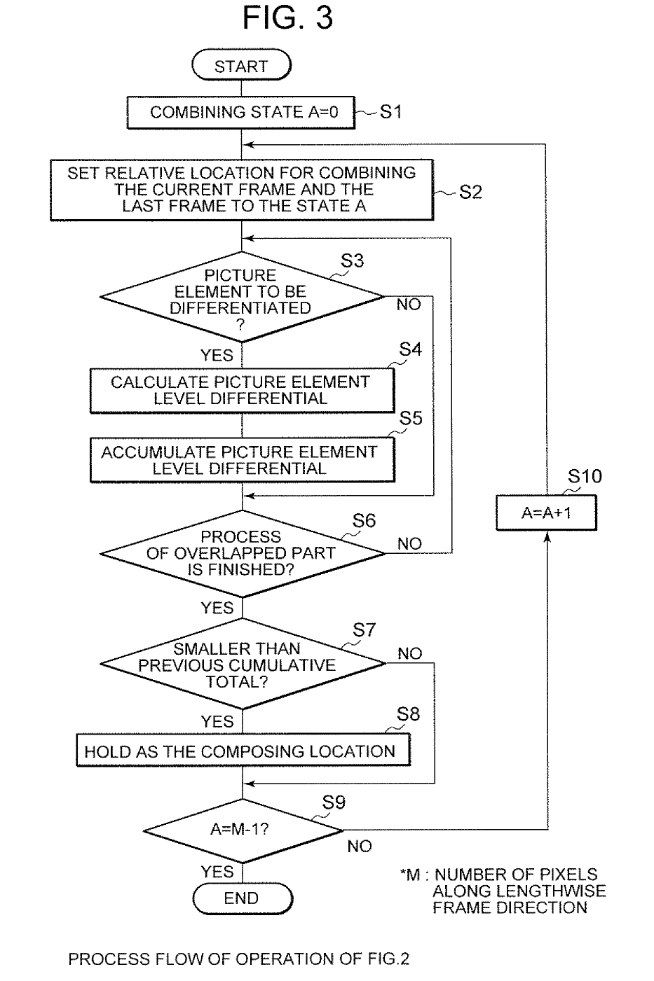

FIG. 4: An explanatory diagram of the operation of FIG. 2.

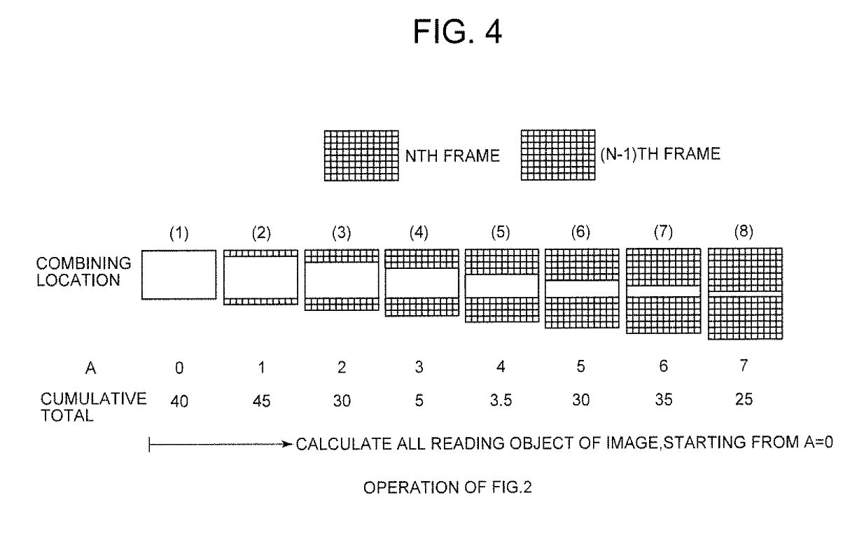

FIG. 5: A process flow diagram of the operation of the composing location calculating circuit in FIG. 1.

FIG. 6: An explanatory diagram of the operation of FIG. 1.

FIG. 7: An explanatory diagram of the method for calculating the speed in FIG. 1.

FIGS. 8A-8B: An explanatory diagram of the method for calculating the cumulative value in FIG. 1.

FIG. 9: A configuration diagram of a composing location calculating circuit according to the second embodiment of the present invention.

FIG. 10: A process flow diagram of the operation of the composing location calculating circuit in FIG. 9.

FIG. 11: A configuration diagram of a composing location calculating circuit according to the third embodiment of the present invention.

FIG. 12: An explanatory diagram of the operation of FIG. 2.

### DETAILED DESCRIPTION OF THE PREFERRED EMBODIMENTS

The above mentioned and other objectives of the present invention, and the novelty of the present invention will become clear more thoroughly by reading the following description of the preferred embodiments referring to the drawings. However, the drawings are only for the explanation, and do not limit the scope of the present invention.

### 1. FIRST EMBODIMENT

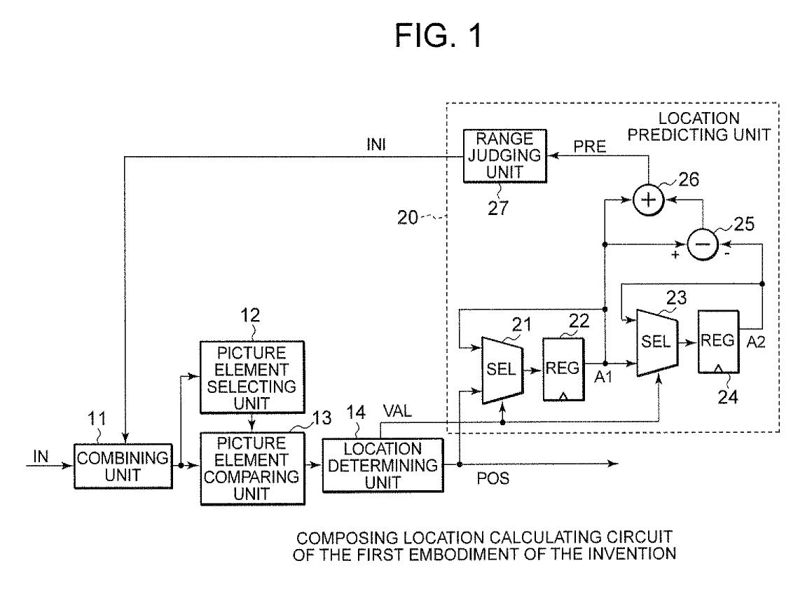

FIG. 1 is a configuration diagram of the first embodiment of the invention. A composing location calculating circuit thereof is a circuit for calculating a composing location for composing a composite image from partial images of fingerprint outputted periodically by a sensor or partial images stored temporary in a partial image memory, in an image processing apparatus for reading periodically the partial fingerprint by moving relatively the finger and the long sensor in order to compose a composite fingerprint image.

The above mentioned composing location calculating circuit includes a combining unit 11 for combining the current frame and the previous frame held in the partial image memory, etc. not shown in the drawings accordingly to an initial value INI of the combining location to extract the overlapped part. A picture selecting unit 12 and picture element comparing unit 13 are connected to the output side of the combining unit 11. The picture selecting unit 12 selects picture elements to be differentiated between the current frame and the previous frame. The picture element comparing unit 13 differentiates brightness between the picture elements selected by the above picture selecting unit 12, and compares the cumulative value accumulated by the above differential with the cumulative value accumulated by the differential between the picture elements of the case where the combing location is changed.

The picture comparing unit 13 calculates the cumulative value of the differential between the picture elements selected by the picture selecting unit 12 at each of the combining locations, and finishes calculating the cumulative value of the differential corresponding to the current combining location when the above cumulative value becomes larger than the previous cumulative value calculated by the differential at the prior combining location. A location determining unit 14 is connected to the output side of the picture comparing unit 13

When a composing location POS is determined based on the result from the comparing unit 13, the location determining unit 14 outputs a valid signal VAL with the above determined composing location POS. The composing location POS and the valid signal VAL are provided a location predicting unit 20. Furthermore, the composing location POS is provided a composite image memory circuit for composing the composite image, not shown in the drawings.

The location predicting unit 20 predicts a composing location for the current frame by the relative frame moving speed acquired by detecting the speed differential of the composing location POS, and gives the above prediction to the combining unit 11 as a initial value INI of the combining location.

The above location predicting unit 20 includes registers (RES) 22, 24 for holding the one-frame-before and the two-frames-before composing locations POS in order to detect the speed change. That is, the composing location POS outputted from the location determining unit 14 is provided to a first input side of a selector (SEL) 21, and is provided to the register 22 through the above selector 21.

Furthermore, the output side of the register 22 is connected to the second input side of the selector 21 and the first input side of the selector 23, and is provided to the register 24 through the above selector 23. The output side of the register 24 is connected to the second input side of the selector 23. The selectors 21, 23 select the first input sides when validity of the composing location POS is indicated by the valid signal VAL. The registers 22, 24 hold the outputs of the selectors 21, 23 by the clock signal corresponding to the frame, respectively.

The one-frame-before and two-frames-before composing locations POS held by the registers 22, 24 are differentiated by a subtracter 25 and the subtracting result by the above subtracter 25 and the data held by the register 22 are added by an adder 26. Subsequently, the adding result of the adder 26 is provided to a range-judging unit 27 as a predicted value PRE.

The range-judging unit 27 judges whether the predicted value PRE from the adder 26 is within the frame range of the lengthwise frame direction or the lateral frame direction, and in the case where the above value is not within the frame range, the above value is changed and outputted to the combining unit 11 as the initial value INI of the combining location. That is, in the case where the predicted value PRE is within 0 to M−1 of the number of pixels along the lengthwise or the lateral frame direction, the range-judging unit 27 outputs the above predicted value as the initial value INI, in the case where the above predicted value is less than 0, the range-judging unit 27 outputs zero, and in the case where the above predicted value is more than M, the range-judging unit 27 outputs M−1.

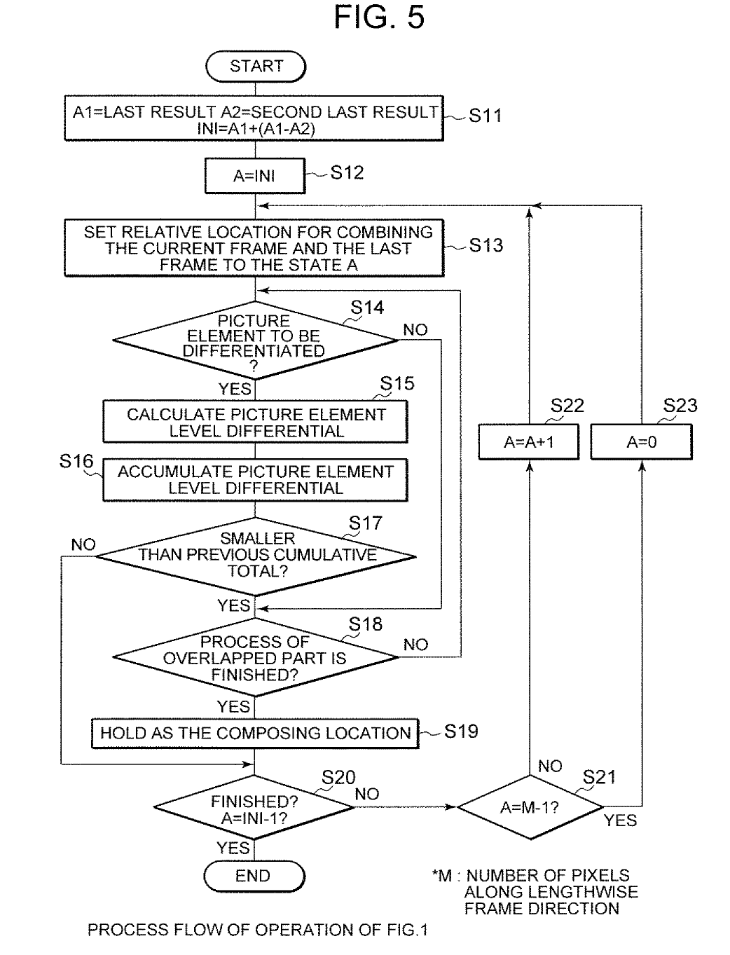

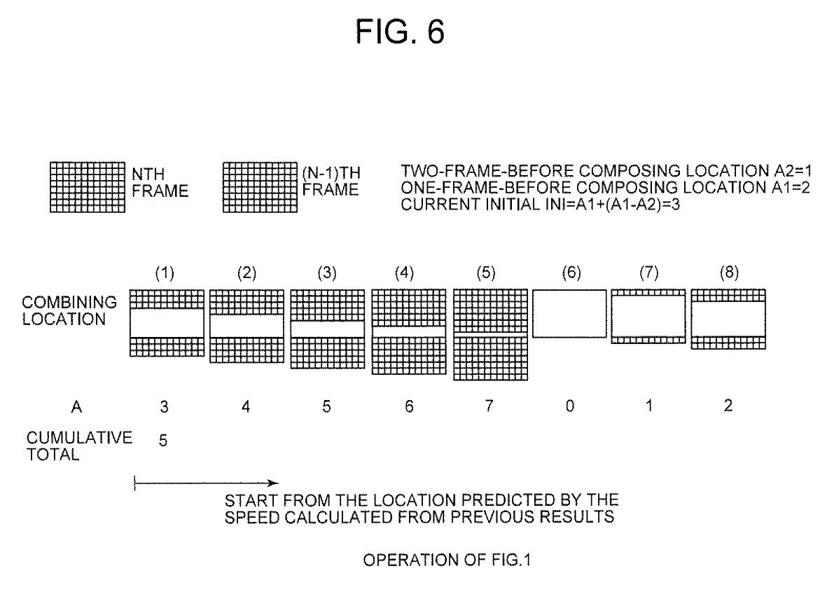

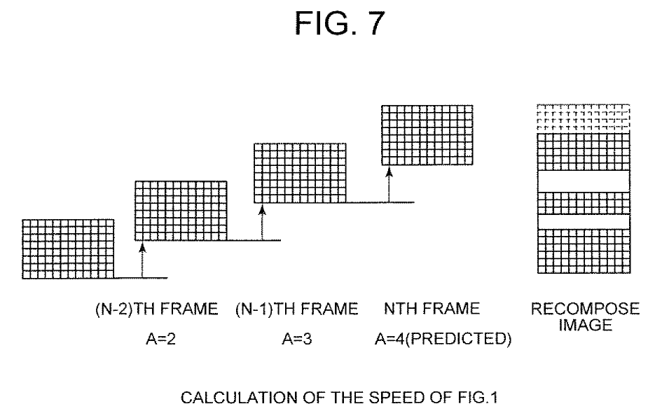

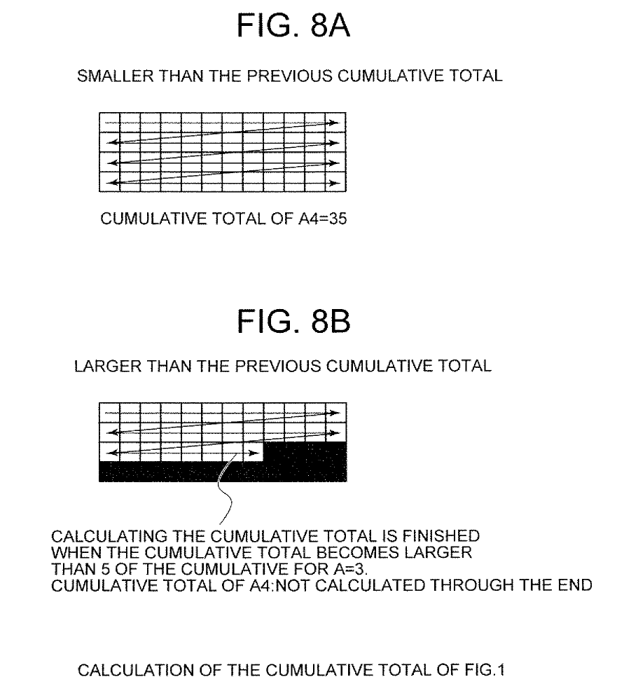

FIG. 5 is a process flow diagram showing the operation of the composing location calculating circuit of FIG. 1. FIG. 6 is an explanatory diagram of the operations of FIG. 1. FIG. 7 is an explanatory diagram of the calculating method of the speed shown in FIG. 1. FIG. 8 is an explanatory diagram of the calculating method of the cumulative value shown in FIG. 1.

The process for detecting the composing location in FIG. 1 will be explained based on the above drawings as below. Detecting the composing location POS in the lengthwise direction will be explained as below, however, detecting the composing location POS in the lateral direction is done by the same operation as in the lengthwise direction. The size of input frame IN is assumed to be 12×8 pixels in the following explanation.

The frames IN of partial image are sequentially inputted to the combining unit 11 from the partial image memory not shown in the drawings, and at the time point when the combing location POS corresponding to one of the frames IN is determined, the above determined composing location POS, that is, a combining relative location A (hereinafter referred to as “the one-frame-before result A”) is outputted with the valid signal VAL from the location determining unit 14.

The one-frame-before result A1 of the composing location POS is provided to the composite image combining memory not shown in the drawings and to the location-predicting unit 20 as well, and is held by the register 22. Simultaneously, a relative location A of the two-frames-before frame (hereinafter referred to as “the two-frames-before result A2”) is shifted from the register 22 to the register 24 and held by the register 24. Consequently, assuming that the partial image frame IN moves at a constant speed shown in FIG. 7, the subtracter 25 and the adder 26 of the location predicting unit 20 calculate the predicted value PRE of the relative combining location A for the next frame by the following formula based on the one-frame-before result A1 and the two-frames-before result A2.

PRE=A1+(A1−A2)

The predicted value PRE is provided to the range-judging unit 27, and in the case where the above value is within 0 to 8−1 of the number of the pixels along the lengthwise frame direction, the range-judging unit 27 outputs the above value as the initial value INI, in the case where the above value is less than 0, the range-judging unit 27 outputs zero as the initial value INI, and in the case where the above value is more than 8, the range-judging unit 27 outputs 7 as the initial value INI (step S11 of FIG. 5). The combining unit 11 sets the combining relative location A to the above initial value INI (step S12).

After the subsequent frame IN (Nth frame) is inputted to the combining unit 11, the combining unit 11 combines the Nth frame and the (N−1)th frame according to the set relative location A (step S13).

Assuming INI=3, the picture element comparing unit 13 differentiates (step S15) the picture elements to be differentiated selected by the picture element selecting unit 12 (step S14), in the sequential order starting from the first differentiation in the state that the (N−1)th frame is moved downward relatively by three picture element length from the Nth frame (A=3), as shown in FIG. 6, and the picture element comparing unit 13 adds the above differentiating result to the cumulative value (step S15). The above-calculated cumulative value is provided to the location determining-unit 14. The cumulative value of 5 calculated for the first time (A=3) is held as a previous cumulative value.

For the second differentiation, the picture elements to be differentiated is differentiated and added to the cumulative value in the state that the current frame is moved downward by four-picture-element length. Every time when the cumulative value is calculated one by one picture element, the current cumulative value is compared with the previous cumulative value (step S17). Subsequently, in the case where the current cumulative value is not more than the previous cumulative value (step S18), the rest of the picture elements to be differentiated are repeatedly differentiated and added to the cumulative value (step S14 to S18). And when the process for differentiating all the picture elements to be differentiated and adding to the cumulative value is finished (step S18), as shown in FIG. 8(a), and the current cumulative value is smaller than the previous cumulative value, the previous cumulative value is updated by the current cumulative value. At the same time, the current relative location A is held as the updated composing location POS (step S19).

Meanwhile, as shown in FIG. 8(b), in the case where the current cumulative value becomes larger than the previous cumulative value during calculating the cumulative value (step S20), calculating the cumulative value for the current combining location is finished without calculating the rest of the picture elements to be differentiated, and the process proceeded to the process for the subsequent combining location (step S21).

The above process is sequentially repeated till A=7 (step S22), and the same process is repeated till A=2 after the process is returned back to the process for A=0 (step S23) at the time point when the process for A=7 is finished.

When calculating the cumulative value of the picture level differentials for the composing locations POS for all values of the relative location A, that is, 3 to 7 and 0 to 2, is finished, the valid signal VAL is outputted from the location determining unit 14. At the above time point, the composing location POS outputted from the location-determining unit 14 is the relative location A having the minimum cumulative value.

As explained before, the composing location calculating circuit according to the first embodiment includes the location predicting unit 20 for predicting the relative combining location A for the next frame, using the composing location A1 of the one-frame-before frame and the composing location A2 of the two-frames-before frame on assumption that the frame moves at a constant speed. The above composing location calculating circuit further includes the picture element comparing 13 for finishing the calculating process of the cumulative value for the current combining location at the time point when the above cumulative value becomes larger than the previous cumulative value calculated for the last combining location during calculating the cumulative value of the differentials of the selected picture elements.

By the above configuration, the possibility becomes higher that the location predicting unit 20 selects first the combining location corresponding to the objective composing location and the cumulative value of the picture element differentials currently calculated becomes smaller. Subsequently, since the process for calculating the cumulative value is sequentially done by the picture element comparing unit 13 and the process for calculating the cumulative value is finished when the cumulative value becomes larger than the previous cumulative value, the number of times of calculating the cumulative value can be reduced. Consequently, there is an advantage that the processing time for calculating the composing location can be reduced without worsening the combining precision.

### 2. SECOND EMBODIMENT

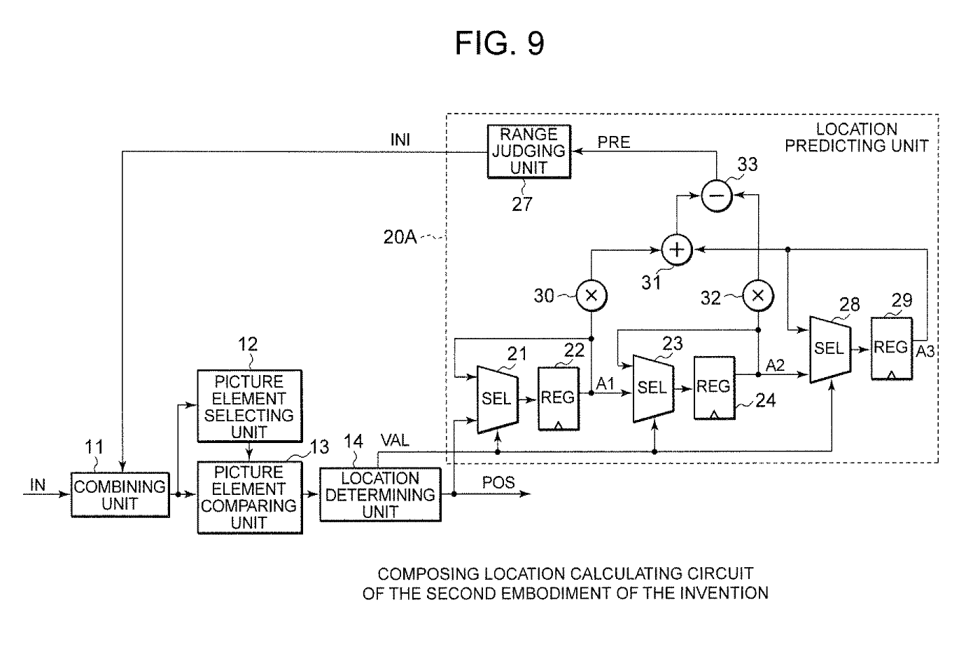

FIG. 9 is a configuration diagram of a composing location calculating circuit according to the second embodiment of the present invention, and the same numerals as in FIG. 1 are given to the elements identical to the ones of FIG. 1.

The above composing location calculating includes a location predicting unit 20A having a different predicting method instead of the location predicting unit 20 in FIG. 1.

In other words, the above location predicting unit 20A calculates the moving speed and the acceleration of the frame based on the composing locations POS of the one-frame-before frame to the three-frame-before frame, and the above location predicting unit 20A generates the initial value INI of the combining location based on the above acceleration and gives the above initial value INI to the combining unit 11.

The above location predicting unit 20A includes a register 29 for holding the composing location POS of the three-frame-before frame, in addition to the registers 22, 24 for holding composing locations POS of the one-frame-before and the two-frames-before frames. In other words, the composing location POS outputted from the location-determining unit 14 is provided to the first input side of the selector 21, and is provided to the register 21 through the above selector 21. Meanwhile, the output side of the register 22 is connected to the second input side of the selector 21 and the first input side of the selector 23 as well, and the composing location POS is provided to the register 24 through the selector 23. The output side of the register 24 is connected to the second input side of the selector 23.

Furthermore, the output side of the register 24 is provided to the first input side of the selector 28, and is provided to the register 29 through 28. The output side of the register 29 is connected to the second input side of the register 28. The selectors 21, 23, 28 select the first input sides in the case where validness of the composing location POS is indicated by the valid signal VAL. Meanwhile, the registers 22, 24, 29 hold the outputs from the selectors 21, 23, 29, respectively, by the clock signal corresponding to the frame.

The composing location POS (A1) of the one-frame-before frame being held by the register 22 is multiplied by three times by an multiplier 30, and is added to the composing location POS (A3) of the three-frame-before frame being held by the register 29. Meanwhile, the composing location POS (A2) of the two-frames-before frame being held by the register 24 is multiplied by three times by an multiplier 32, and is subtracted from the adding result of an adder 31 to generate the predicted value PRE. Subsequently, the predicted value PRE is provided to a range judging unit 27. Other configurations are the same as in FIG. 1.

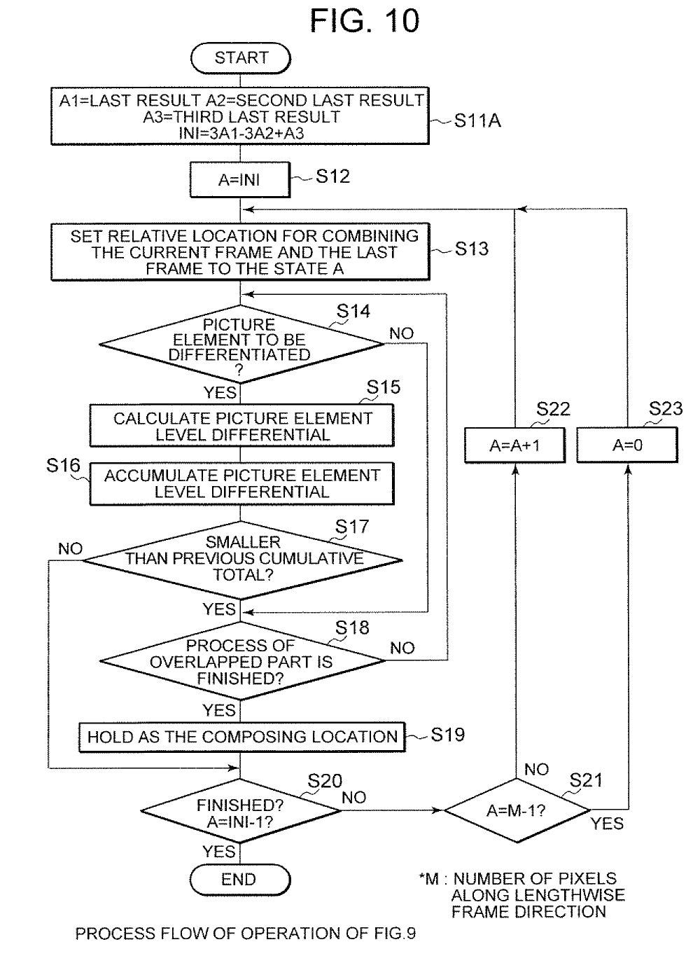

FIG. 10 is a process flow diagram showing the operations of the composing location calculating circuit in FIG. 9, and the same numerals as in FIG. 5 are given to the elements identical to the ones of FIG. 5.

The difference between the above composing location calculating circuit and the composing location calculating circuit according to the first embodiment is whether the initial value INI provided to the combining unit 11 is generated based on the moving speed of the previous frames, or the moving speed and the acceleration of the previous frames. Other operations are the same as in the first embodiment. Consequently, other steps are the same as in the first embodiment except that a step S11A for setting the initial value is different, in FIG. 10, as well.

The step S11A is a process processed in the location predicting unit 20A, and the one-frame-before relative location A1 of the composing location POS is held in the register 22 of the location predicting unit 20A. Simultaneously, a relative combining location A2 for combining the two-frames-before frame is shifted from the register 22 to the register 24 and held by the register 24, and the relative location A3 for combining the three-frame-before frame is shifted from the register 24 to the register 29 and held by the register 29. Consequently, assuming that the partial image frame IN moves at an acceleration, the multipliers 30, 32, the adder 31, and the subtracter 33 of the location predicting unit 20A calculate the predicted value PRE of the relative location A for combining the next frame by the following formula based on the relative locations A1, A2, A3.

PRE=((A1−A2)−(A2−A3))+(A1−A2)+A1=3A1−3A2+A3

The predicted value PRE is provided to the range-judging unit 27, and in the case where the above value is within 0 to 8−1 of the number of the pixels along the lengthwise frame direction, the range-judging unit 27 outputs the above value as the initial value INI, in the case where the above value is less than 0, the range-judging unit 27 outputs zero as the initial value INI, and in the case where the above value is more than 8, the range-judging unit 27 outputs 7 as the initial value INI. The subsequent processes are the same as in the first embodiment.

As explained before, the composing location calculating circuit according to the second embodiment includes the location predicting unit 20A for predicting the composing location POS of the next frame using the composing locations A1 to A3 of the one-frame-before frame to the three-frame-before frame on assumption that the frame moves at an acceleration and for outputting the above predicted value as the initial value INI. Consequently, since the predicted location including the acceleration can be calculated, the predicting precision is improved, and then the same advantages as in the first embodiment can be achieved even when the input partial image frame IN does not move at a constant speed.

### 3. THIRD EMBODIMENT

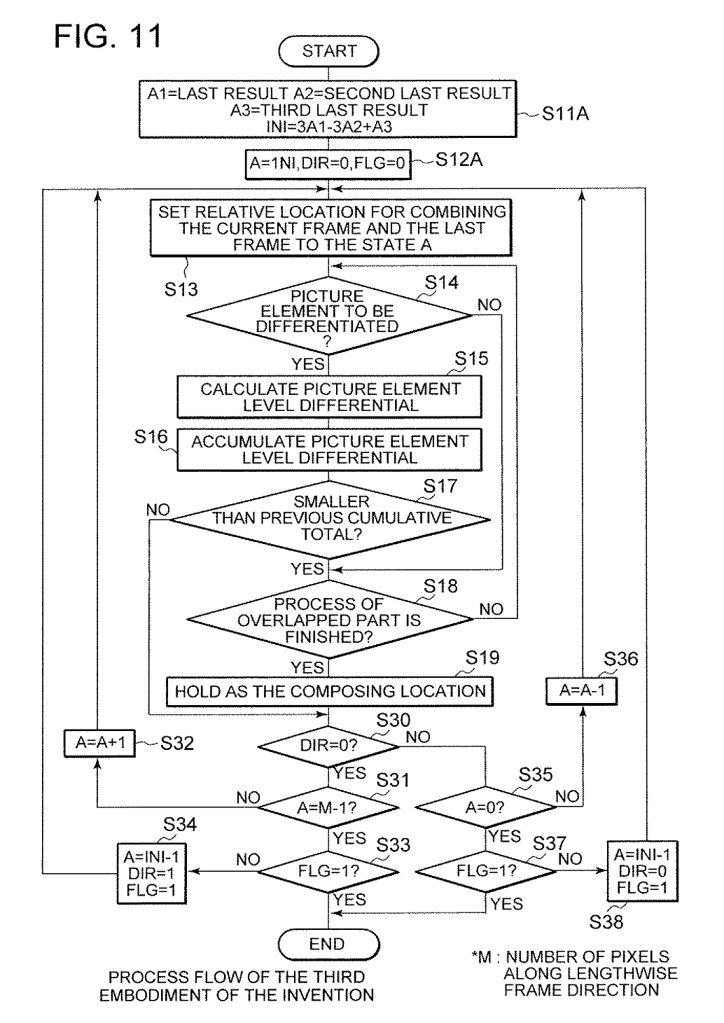

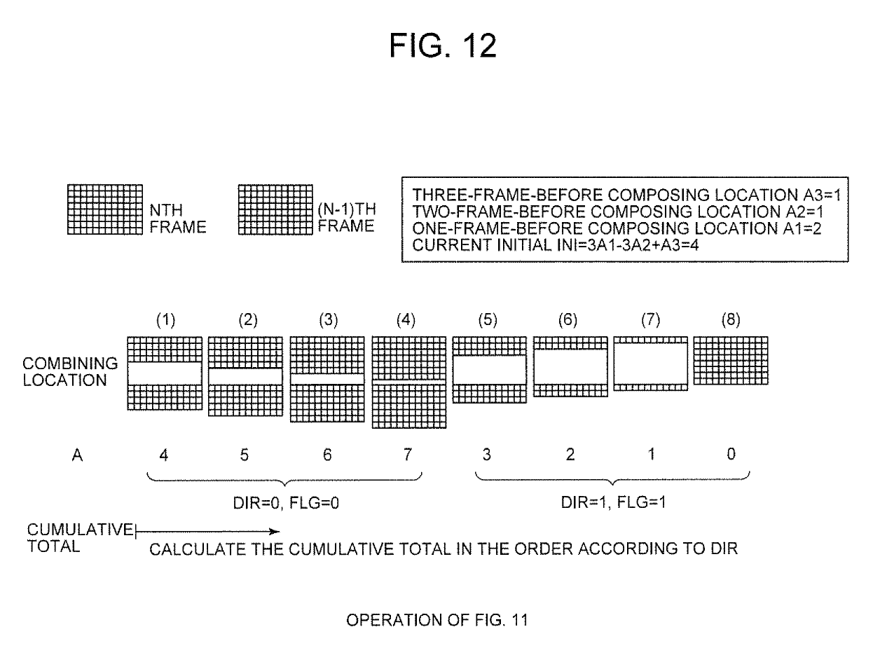

FIG. 11 is a process flow diagram of a composing location calculating circuit according to the third embodiment of the present invention, and FIG. 12 is an explanatory diagram of the operations of the above FIG. 11. The above process according to the third embodiment is processed by a composing location calculating circuit having the same configuration as in FIG. 9, in place of the process flow of FIG. 10, and the same numerals are given to elements identical to the ones in FIG. 10.

A step S11A is processed in the location predicting unit 20A and the predicted value PRE is calculated by the following formula based on the composing locations A1, A2, A3 of the previous three frames just before the current frame IN.

PRE=((A1−A2)−(A2−A3))+(A1−A2)+A1=3A1−3A2+A3

The predicted value PRE is provided to the range judging unit 27, and in the case where the above value is within 0 to 8−1 of the number of the pixels along the lengthwise frame direction, the range-judging unit 27 outputs the above value as the initial value INI, in the case where the above value is less than 0, the range-judging unit 27 outputs zero as the initial value INI, and in the case where the above value is more than 8, the range-judging unit 27 outputs 7 as the initial value INI.

In a step 12A, the combining unit 11 sets the relative combining location A to the initial value INI, and sets a direction indicator DIR and a flag FLG of processing registers to zero. The above direction indicator DIR indicates the direction to move the combining location, and, for example, in the case where the DIR=0, the direction is upward, and in the case where the DIR=1, the direction is downward.

In the case where the initial value is four, and both of the direction indicator DIR and the flag FLG are zero, a cumulative value is first calculated in the state that A is four (steps S13 to S19). Subsequently, in the case where the direction indicator DIR is zero, it is judged whether the relative location A is M−1 of the number of the pixels along the lengthwise frame direction, or not (step S30 to S31). Meanwhile, in the case where the direction indicator DIR is one, it is nudged whether the relative location A is the frame zero, or not (step S30 to S35).

In the above case, since DIR=0, the relative location A is compared with M−1 (=7) of the number of pixels along the lengthwise frame direction (step S31), and then the relative location A is added by one because of discrepancy between the above relative location and the above M−1 (step S32). The above processes (steps S13 to S31) are repeated till A=7.

When A becomes 7, it is judged whether the flag FLG is 0 or 1 (step S33). At the time point thereof, since FLG=0, the relative location A is set to (the initial value INI−1), and the direction indicator DIR is secondly set to one in order to reverse the searching direction. Furthermore, the flag FLG is set to one in order to finish the process when the relative location A becomes −1 or 0 for the next time (step S34) Subsequently, the process is returned to the step S13.

In the returned step, the same processes are done by changing the relative locations for combining in the order of A=3, 2, 1, and so on.

After the processes of the steps S13 to S19 are done for the case where A=3, it is judged whether or not A is zero, because the direction indicator DIR has become 1 (steps S30, S35). In the above case, since A=3, A is subtracted by one (step S36). The aforementioned processes (steps S13 to S36) are repeated till A becomes zero.

When A becomes zero, it is judged whether the flag FLG is zero or one (step S37). At the above time point, since FLG=1, the process of calculating the cumulative value for researching the composing location POS is finished.

When the process of calculating the cumulative value of the picture element level differentials for the combining locations corresponding to all the values of the relative locations A, that is, 3 to 7 and 2 to 0, is finished, the valid signal VAL is outputted from the location determining unit 14. At the above time point, the composing location POS outputted from the location determining unit 14 has become the value of the relative location A having the minimum cumulative value.

As explained before, the composing location calculating process according to the third embodiment is configured that the composing location is searched by moving sequentially the relative combining location A along one direction from the initial value INI, and then the composing location is searched again by moving sequentially the relative combining location A along the reversed direction after returning to the initial value INI. By the above configuration, the possibility to calculate the minimum cumulative value earlier than by the way of the second embodiment to move sequentially the relative combining location A along only one direction becomes higher. Consequently, the process time is further shortened than in the second embodiment.

In addition, the present invention is not limited to the above embodiments and various modifications are possible. The above modifications are as follows.

(a) The process of fingerprint images is explained before, however, the reading object of image is not limited to fingerprints. In other words, the present invention can be applied to all image processing apparatuses for composing composite images by combining sequentially inputted images including partial images overlapped each other.

(b) The case of moving the frame combining location in the lengthwise direction is explained before, however, the present invention can be applied to all similar image processing apparatuses providing that the frame combining location needs to be moved in a lateral or an oblique direction accordingly to the relative moving direction between the reading object of image and the sensor.

(c) The frame size in not limited to 12×8 pixels.

(d) The composing location POS of the current frame IN is predicted based on the composing locations POS corresponding to the last two to three frames, and provided to the combining unit 11 as the initial value INI, however, any number can be applied to the number of the previous frames used for the above prediction.

(e) According to the third embodiment, the case is shown where searching the relative combining location A is done in the searching direction starting from the initial value INI to the maximum or the minimum value of the combining location, and subsequently the above searching is searched by returning the searching direction to the initial value INI and reversing the searching direction, however, the case is applicable where the searching is done from the initial value to the values moved alternatively in the forward and backward direction or the right and left direction.

(f) In the third embodiment, the initial value can be generated by the same location-predicting unit 20 as in the first embodiment.

What is claimed is:

1. An image processing unit for producing composite images by overlapping partial images captured by relative movement of an image to be read and an image sensor within narrower reading range than that of reading object of the image, the image processing unit comprising:
a cumulative value calculation means for calculating a cumulative value of brightness differences of each pixels belonging to overlapped portion which are obtained by overlapping a current partial image and a one-frame-before partial image pixel-by-pixel;
a composing position determination means for generating a combining location, as a composing location, having a minimum cumulative value among the cumulative value calculated by the cumulative value calculation means; and
an image composition means for composing the current partial image and the one-frame-before partial image based on the composing location, wherein the cumulative value calculation means completes a process for combining location in calculation, when currently cumulated value exceeds the calculated cumulative value during the calculation of the cumulative values for each combining location.

2. The image processing unit of claim 1, further including:
a location predicting means for calculating a moving speed of partial images based on composing location of the one-frame-before partial image and the two-frames-before partial image, generating a composing-location initial value by predicting a composing-location of the current partial image based on the moving speed, and giving the initial value to the cumulative value calculation means,
wherein the cumulative value calculation means is configured to control a composing-location order of combining the current partial image and the previous partial image according to the initial value.

3. The image processing unit of claim 1, further comprising:
a location predicting means for calculating a moving speed and acceleration speed of partial image based on the one-frame-before partial image composing-location, the two-frames-before partial image composing-location, and the three-frames-before partial image composing-location, generating a initial value of composing-location by predicting a composing-location of the current partial image based on the moving speed and the acceleration speed, and giving the initial value to the cumulative value calculation means,
wherein the cumulative value calculation means controls an order of combining the current partial image and the 25 one-frame-before partial image based on the initial value.

4. The image processing apparatus of claim 2, wherein said cumulative value calculation means calculates the cumulative value corresponding to each of the combining locations by moving the combining location in a predetermined direction and recalculates the cumulative value by moving the combining location pixel-by-pixel from an initial combining location, when the combining location reaches the maximum or minimum position.

5. An image processing method for producing composite images by overlapping partial images captured by relative movement of an image to be read and an image sensor within narrower reading range than that of reading object of the image, the image processing method comprising the steps of:
an initial value generating step for generating an initial combining location value of a current partial image based on combining locations corresponding to each of a plurality of combining location for previous partial images;
a cumulative value calculation step for completing a calculation of cumulative value of a currently-calculated combining location when currently-calculated cumulative value exceeds the cumulative value of an already-calculated combining location and continuing said calculation when the currently-calculated cumulative value does not exceeds the cumulative value of already-calculated combining location, wherein the calculation is done by calculating a cumulative value of brightness difference between picture elements in an overlapped part, the overlapped part is a portion of images that is configured by combining a current partial image and a one-frame-before partial image after moving said current partial image and said one-frame-before partial image from an initial location to a predetermined direction one by one;
a location determining step for generating a combining location with a minimum cumulative value among said calculated cumulative values; and
an image composing step for composing the current partial image and the one-frame-before partial image based on the composing location.

6. The image processing method of claim 5, wherein said cumulative value calculating step is configured to calculate the cumulative value corresponding to each of the combining locations by moving the combining location in a predetermined direction starting from the initial location, and subsequently moving the combining location in a reverse direction pixel by pixel when the current combining location reaches a maximum position or a minimum position.

7. The image processing method of claim 5, wherein the initial value generating step is configured to calculate a moving speed of partial images based on composing locations of the one-frame-before partial image and the two-time-before partial image, and generate a composing-location initial value by predicting a composing location of the current partial image based on the moving speed.

8. The image processing method of claim 5, wherein the initial value generating step is configured to calculate a moving speed and an acceleration speed of partial images based on composing locations of the one-frame-before partial image, the two-frames-before partial image, and the three-frames-before partial image, and generate a composing-location initial value by predicting a composing location of the current partial image based on said moving speed and said acceleration speed.
